(19) United States
(12) Patent Application Publication
(10) Pub. No.: US 2024/0303501 A1
(43) Pub. Date: Sep. 12, 2024

(54) IMITATION AND REINFORCEMENT LEARNING FOR MULTI-AGENT SIMULATION

(71) Applicant: Waabi Innovation Inc., Toronto (CA)

(72) Inventors: Chris ZHANG, Toronto (CA); James TU, Toronto (CA); Lunjun ZHANG, Toronto (CA); Kelvin WONG, Toronto (CA); Simon SUO, Toronto (CA); Raquel URTASUN, Toronto (CA)

(73) Assignee: Waabi Innovation Inc., Toronto (CA)

(21) Appl. No.: 18/598,975

(22) Filed: Mar. 7, 2024

Related U.S. Application Data
(60) Provisional application No. 63/450,640, filed on Mar. 7, 2023.

(51) Int. Cl. G06N 3/092

(52) U.S. Cl. CPC G06N 3/092

(57) ABSTRACT

Imitation and reinforcement learning for multi-agent simulation includes performing operations. The operations include obtaining a first real-world scenario of agents moving according to first trajectories and simulating the first real-world scenario in a virtual world to generate first simulated states. The simulating includes processing, by an agent model, the first simulated states for the agents to obtain second trajectories. For each of at least a subset of the agents, a difference between a first corresponding trajectory of the agent and a second corresponding trajectory of the agent is calculated and determining an imitation loss is determined based on the difference. The operations further include evaluating the second trajectories according to a reward function to generate a reinforcement learning loss, calculating a total loss as a combination of the imitation loss and the reinforcement learning loss, and updating the agent model using the total loss.

### CROSS REFERENCE TO RELATED APPLICATIONS

This application is a non-provisional application of, and thereby claims benefit to, U.S. Patent Application Ser. No. 63/450,640 filed on Mar. 7, 2023. U.S. Patent Application Ser. No. 63/450,640 is incorporated herein by reference in its entirety.

### BACKGROUND

A virtual world is an environment in which a player may move in three dimensions as if the player were in the real world. The player operates independently of the instructions of the virtual world. In addition to the player, the virtual world may also have computerized agents that are part of the virtual world. Similar to the player, the agents also move through the virtual world. In some virtual worlds, a goal of the virtual world is to be realistic or to have some elements of realism. Namely, even if the virtual world is not a replica of the real world, the virtual world has elements that could be in the real world. One source of realism is the movement of the agents in the virtual world. Namely, a goal is that, for a particular scenario, the agents move in the virtual world in the same way the agents would move in the real world given the same scenario.

### SUMMARY

In general, in one aspect, one or more embodiments relate to a method. The method that includes obtaining a first real-world scenario of agents moving according to first trajectories and simulating the first real-world scenario in a virtual world to generate first simulated states. The simulating includes processing, by an agent model, the first simulated states for the agents in the virtual world to obtain second trajectories of the agents. For each of at least a subset of the agents, the method includes calculating a difference between a first corresponding trajectory of the agent and a second corresponding trajectory of the agent, wherein the first corresponding trajectory is in the first trajectories and the second corresponding trajectory is in the second trajectories and determining an imitation loss for the agent based on the difference. The method further includes evaluating the second trajectories according to a reward function to generate a reinforcement learning loss, calculating a total loss as a combination of the imitation loss and the reinforcement learning loss, and updating the agent model using the total loss.

In general, in one aspect, one or more embodiments relate to a system that includes a computer processor and a non-transitory computer readable medium for causing the computer processor to perform operations. The operations include obtaining a first real-world scenario of agents moving according to first trajectories and simulating the first real-world scenario in a virtual world to generate first simulated states. The simulating includes processing, by an agent model, the first simulated states for the agents in the virtual world to obtain second trajectories of the agents. For each of at least a subset of the agents, the operations include calculating a difference between a first corresponding trajectory of the agent and a second corresponding trajectory of the agent, wherein the first corresponding trajectory is in the first trajectories and the second corresponding trajectory is in the second trajectories and determining an imitation loss for the agent based on the difference. The operation further include evaluating the second trajectories according to a reward function to generate a reinforcement learning loss, calculating a total loss as a combination of the imitation loss and the reinforcement learning loss, and updating the agent model using the total loss.

In general, in one aspect, one or more embodiments relate to a non-transitory computer readable medium that includes computer readable program code for causing a computer system to perform operations. The operations include obtaining a first real-world scenario of agents moving according to first trajectories and simulating the first real-world scenario in a virtual world to generate first simulated states. The simulating includes processing, by an agent model, the first simulated states for the agents in the virtual world to obtain second trajectories of the agents. For each of at least a subset of the agents, the operations include calculating a difference between a first corresponding trajectory of the agent and a second corresponding trajectory of the agent, wherein the first corresponding trajectory is in the first trajectories and the second corresponding trajectory is in the second trajectories and determining an imitation loss for the agent based on the difference. The operation further include evaluating the second trajectories according to a reward function to generate a reinforcement learning loss, calculating a total loss as a combination of the imitation loss and the reinforcement learning loss, and updating the agent model using the total loss.

Other aspects of the invention will be apparent from the following description and the appended claims.

### BRIEF DESCRIPTION OF DRAWINGS

FIG. 1 shows a diagram of a simulator for testing or training an autonomous system with a virtual driver in accordance with one or more embodiments.

FIG. 2 shows a flowchart for performing a simulation for training a virtual driver in accordance with one or more embodiments of the invention.

FIG. 3 shows a diagram of an agent model trainer in accordance with one or more embodiments of the invention.

FIG. 4 shows a diagram of an agent model in accordance with one or more embodiments of the invention.

FIG. 5 shows a flowchart for training an agent model in accordance with one or more embodiments of the invention.

FIG. 6 shows an example flow diagram of agent model training in accordance with one or more embodiments of the invention.

FIGS. 7A and 7B show a computing system in accordance with one or more embodiments of the invention.

Like elements in the various figures are denoted by like reference numerals for consistency.

### DETAILED DESCRIPTION

In general, embodiments are directed to performing imitation and reinforcement learning for multi-agent simulation. Specifically, one or more embodiments are directed to generating and training an agent model that controls the actions of the agents in a virtual world. The virtual world is an environment in which at least one independent player may move in three dimensions as if the player were in the real world. The player in the virtual world may be a human, a virtual driver of an autonomous system, or other computer software. The virtual world may also include computerized agents that may also move through the virtual world like the player. An agent model controls the movement of the agents in the virtual world. For example, the agent model may control the speed and direction of the agents, the trajectory of the agents. To be realistic, agents should react in the virtual world similar to how agents react in the real world. Specifically, if a player is moving in the virtual world, the computerized agents should react to the player, other agents, and the environment the same way in which real-world agents would react to the player, other agents, and the environment in the real world. Thus, a goal of training the agent model is to produce a more realistic interactions with the agent. One or more embodiments perform both imitation learning and reinforcement learning of the agent model in a closed-loop system.

Imitation learning is through training the agent model to imitate real-world scenarios. A real world-scenario is captured by the system. The real-world scenario is simulated in the virtual world using the agent model for the agents. Because the agent model is used during the closed loop simulation, the trajectories of the agents in the virtual world may deviate from the trajectories of the agents in the virtual world. The imitation loss is calculated based on the amount of deviation.

The reinforcement learning is based on the trajectories of each agent in the virtual world when operating with a real-world scenario or with a new scenario. For reinforcement learning, the trajectories of the agent in the virtual world are evaluated using a reward function. For example, the reward function may penalize trajectories that do not have a collision or deviate from pathways in the geographic region. Based on the evaluation with the reward function, a reinforcement learning loss is calculated.

The agent model is updated with a total loss calculated from the reinforcement learning loss and the imitation loss. For example, the total loss may be backpropagated through the agent model to create an updated agent model. Through the iterative updating process, the agent model more accurately causes agents to move in the virtual world as if the agents where in the real world.

Embodiments of the invention may be used as part of generating a simulated environment for the training and testing of autonomous systems. An autonomous system is a self-driving mode of transportation that does not require a human pilot or human driver to move and react to the real-world environment. Rather, the autonomous system includes a virtual driver that is the decision-making portion of the autonomous system. The virtual driver is an artificial intelligence system that learns how to interact in the real world. The autonomous system may be completely autonomous or semi-autonomous. As a mode of transportation, the autonomous system is contained in a housing configured to move through a real-world environment. Examples of autonomous systems include self-driving vehicles (e.g., self-driving trucks and cars), drones, airplanes, robots, etc. The virtual driver is the software that makes decisions and causes the autonomous system to interact with the real-world including moving, signaling, and stopping or maintaining a current state.

The real-world environment is the portion of the real world through which the autonomous system, when trained, is designed to move. Thus, the real-world environment may include interactions with concrete and land, people, animals, other autonomous systems, human driven systems, construction, and other objects as the autonomous system moves from an origin to a destination. In order to interact with the real-world environment, the autonomous system includes various types of sensors, such as LiDAR sensors amongst other types, which are used to obtain measurements of the real-world environment, and cameras that capture images from the real-world environment.

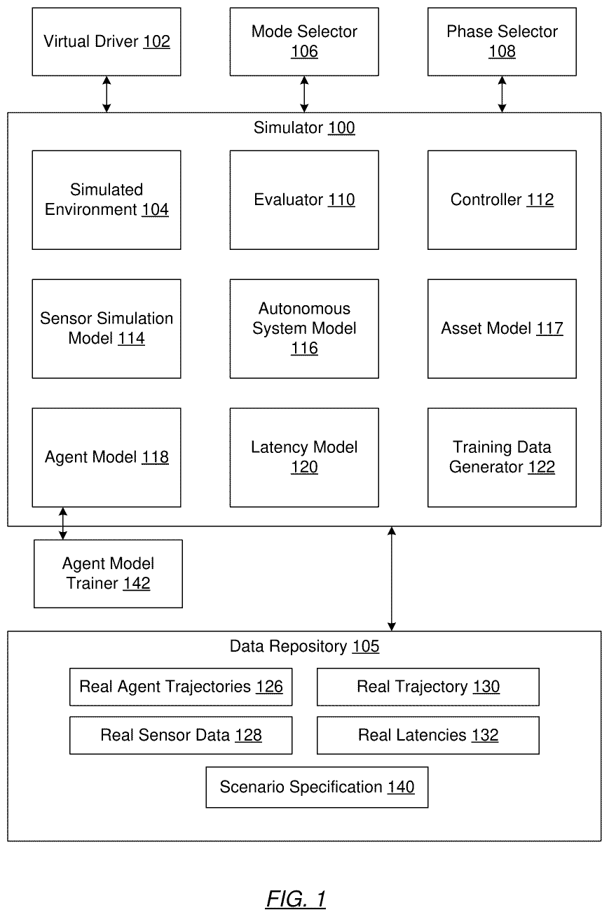

The testing and training of the virtual driver of the autonomous systems in the real-world environment is unsafe because of the accidents that an untrained virtual driver can cause. Thus, as shown in FIG. 1, a simulator (100) is configured to train and test a virtual driver (102) of an autonomous system. For example, the simulator may be a unified, modular, mixed-reality, closed-loop simulator for autonomous systems. The simulator (100) is a configurable simulation framework that enables not only evaluation of different autonomy components in isolation but also as a complete system in a closed-loop manner. The simulator reconstructs “digital twins” of real-world scenarios automatically, enabling accurate evaluation of the virtual driver at scale. The simulator (100) may also be configured to perform mixed-reality simulation that combines real world data and simulated data to create diverse and realistic evaluation variations to provide insight into the virtual driver's performance. The mixed reality closed-loop simulation allows the simulator (100) to analyze the virtual driver's action on counterfactual “what-if” scenarios that did not occur in the real-world. The simulator (100) further includes functionality to simulate and train on rare yet safety-critical scenarios with respect to the entire autonomous system and closed-loop training to enable automatic and scalable improvement of autonomy.

The simulator (100) creates the simulated environment (104) which is a virtual world. The virtual driver (102) is the player in the virtual world. The simulated environment (104) is a simulation of a real-world environment, which may or may not be in actual existence, in which the autonomous system is designed to move. As such, the simulated environment (104) includes a simulation of the objects (i.e., simulated objects or assets) and background in the real world, including the natural objects, construction, buildings and roads, obstacles, as well as other autonomous and non-autonomous objects. The simulated environment simulates the environmental conditions within which the autonomous system may be deployed. Additionally, the simulated environment (104) may be configured to simulate various weather conditions that may affect the inputs to the autonomous systems. The simulated objects may include both stationary and nonstationary objects. Nonstationary objects are agents in the real-world environment.

The simulator (100) also includes an evaluator (110). The evaluator (110) is configured to train and test the virtual driver (102) by creating various scenarios in the simulated environment. Each scenario is a configuration of the simulated environment including, but not limited to, static portions, movement of simulated objects, actions of the simulated objects with each other, and reactions to actions taken by the autonomous system and simulated objects. The evaluator (110) is further configured to evaluate the performance of the virtual driver using a variety of metrics.

The evaluator (110) assesses the performance of the virtual driver throughout the performance of the scenario. Assessing the performance may include applying rules. For example, the rules may be that the automated system does not collide with any other agent, compliance with safety and comfort standards (e.g., passengers not experiencing more than a certain acceleration force within the vehicle), the automated system not deviating from executed trajectory), or other rule. Each rule may be associated with the metric information that relates a degree of breaking the rule with a corresponding score. The evaluator (110) may be implemented as a data-driven neural network that learns to distinguish between good and bad driving behavior. The various metrics of the evaluation system may be leveraged to determine whether the automated system satisfies the requirements of the success criterion for a particular scenario. Further, in addition to system level performance, for modular based virtual drivers, the evaluator may also evaluate individual modules such as segmentation or prediction performance for agents in the scene with respect to the ground truth recorded in the simulator.

The simulator (100) is configured to operate in multiple phases as selected by the phase selector (108) and modes as selected by a mode selector (106). The phase selector (108) and mode selector (106) may be a graphical user interface or application programming interface component that is configured to receive a selection of phase and mode, respectively. The selected phase and mode define the configuration of the simulator (100). Namely, the selected phase and mode define which system components communicate and the operations of the system components.

The phase may be selected using a phase selector (108). The phase may be a training phase or a testing phase. In the training phase, the evaluator (110) provides metric information to the virtual driver (102), which uses the metric information to update the virtual driver (102). The evaluator (110) may further use the metric information to further train the virtual driver (102) by generating scenarios for the virtual driver. In the testing phase, the evaluator (110) does not provide the metric information to the virtual driver. In the testing phase, the evaluator (110) uses the metric information to assess the virtual driver and to develop scenarios for the virtual driver (102).

The mode may be selected by the mode selector (106). The mode defines the degree to which real-world data is used, whether noise is injected into simulated data, the degree of perturbations of real-world data, and whether the scenarios are designed to be adversarial. Example modes include open loop simulation mode, closed loop simulation mode, single module closed loop simulation mode, fuzzy mode, and adversarial mode. In an open loop simulation mode, the virtual driver is evaluated with real world data. In a single module closed loop simulation mode, a single module of the virtual driver is tested. An example of a single module closed loop simulation mode is a localizer closed loop simulation mode in which the simulator evaluates how the localizer estimated pose drifts over time as the scenario progresses in simulation. In a training data simulation mode, simulator is used to generate training data. In a closed loop evaluation mode, the virtual driver and simulation system are executed together to evaluate system performance. In the adversarial mode, the agents are modified to perform adversarial. In the fuzzy mode, noise is injected into the scenario (e.g., to replicate signal processing noise and other types of noise). Other modes may exist without departing from the scope of the system.

The simulator (100) includes the controller (112) which includes functionality to configure the various components of the simulator (100) according to the selected mode and phase. Namely, the controller (112) may modify the configuration of each of the components of the simulator based on the configuration parameters of the simulator (100). Such components include the evaluator (110), the simulated environment (104), an autonomous system model (116), sensor simulation models (114), asset models (117), agent models (118), latency models (120), and a training data generator (122).

The autonomous system model (116) is a detailed model of the autonomous system in which the virtual driver will execute. The autonomous system model (116) includes model, geometry, physical parameters (e.g., mass distribution, points of significance), engine parameters, sensor locations and type, the firing pattern of the sensors, information about the hardware on which the virtual driver executes (e.g., processor power, amount of memory, and other hardware information), and other information about the autonomous system. The various parameters of the autonomous system model may be configurable by the user or another system.

For example, if the autonomous system is a motor vehicle, the modeling and dynamics may include the type of vehicle (e.g., car, truck), make and model, geometry, physical parameters such as the mass distribution, axle positions, type and performance of the engine, etc. The vehicle model may also include information about the sensors on the vehicle (e.g., camera, LiDAR, etc.), the sensors' relative firing synchronization pattern, and the sensors' calibrated extrinsics (e.g., position and orientation) and intrinsics (e.g., focal length). The vehicle model also defines the onboard computer hardware, sensor drivers, controllers, and the autonomy software release under test.

The autonomous system model includes an autonomous system dynamic model. The autonomous system dynamic model is used for dynamics simulation that takes the actuation actions of the virtual driver (e.g., steering angle, desired acceleration) and enacts the actuation actions on the autonomous system in the simulated environment to update the simulated environment and the state of the autonomous system. To update the state, a kinematic motion model may be used, or a dynamics motion model that accounts for the forces applied to the vehicle may be used to determine the state. Within the simulator, with access to real log scenarios with ground truth actuations and vehicle states at each time step, embodiments may also optimize analytical vehicle model parameters or learn parameters of a neural network that infers the new state of the autonomous system given the virtual driver outputs.

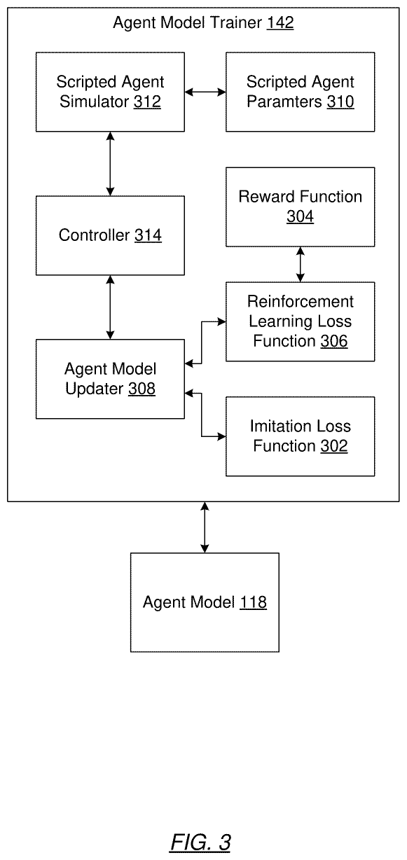

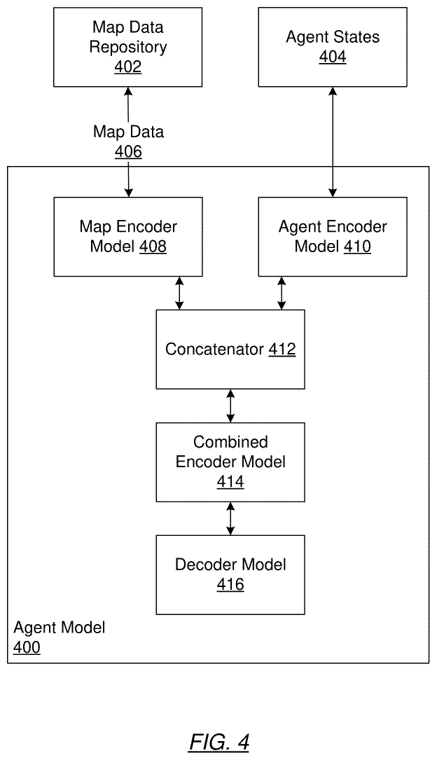

In one or more embodiments, the sensor simulation models (114) models, in the simulated environment, active and passive sensor inputs. Passive sensor inputs capture the visual appearance of the simulated environment including stationary and nonstationary simulated objects from the perspective of one or more cameras based on the simulated position of the camera(s) within the simulated environment. Examples of passive sensor inputs include inertial measurement unit (IMU) and thermal. Active sensor inputs are inputs to the virtual driver of the autonomous system from the active sensors, such as LiDAR, RADAR, global positioning system (GPS), ultrasound, etc. Namely, the active sensor inputs include the measurements taken by the sensors, and the measurements being simulated based on the simulated environment based on the simulated position of the sensor(s) within the simulated environment. By way of an example, the active sensor measurements may be measurements that a LiDAR sensor would make of the simulated environment over time and in relation to the movement of the autonomous system. In one or more embodiments, all or a portion of the sensor simulation models (114) may be or include the rendering system (300) shown in FIG. 3. In such a scenario, the rendering system of the sensor simulation models (114) may perform the operations of FIGS. 4-6.

The sensor simulation models (114) are configured to simulate the sensor observations of the surrounding scene in the simulated environment (104) at each time step according to the sensor configuration on the vehicle platform. When the simulated environment directly represents the real-world environment, without modification, the sensor output may be directly fed into the virtual driver. For light-based sensors, the sensor model simulates light as rays that interact with objects in the scene to generate the sensor data. Depending on the asset representation (e.g., of stationary and nonstationary objects), embodiments may use graphics-based rendering for assets with textured meshes, neural rendering, or a combination of multiple rendering schemes. Leveraging multiple rendering schemes enables customizable world building with improved realism. Because assets are compositional in 3D and support a standard interface of render commands, different asset representations may be composed in a seamless manner to generate the final sensor data. Additionally, for scenarios that replay what happened in the real world and use the same autonomous system as in the real world, the original sensor observations may be replayed at each time step.

Asset models (117) include multiple models, each model modeling a particular type of individual asset in the real world. The assets may include inanimate objects such as construction barriers or traffic signs, parked cars, and background (e.g., vegetation or sky). Each of the entities in a scenario may correspond to an individual asset. As such, an asset model, or instance of a type of asset model, may exist for each of the objects or assets in the scenario. The assets can be composed together to form the three-dimensional simulated environment. An asset model provides all the information needed by the simulator to simulate the asset. The asset model provides the information used by the simulator to represent and simulate the asset in the simulated environment.

Closely related to, and possibly considered part of, the set of asset models (117) are agent models (118). An agent model represents an agent in a scenario. An agent is a sentient being that has an independent decision-making process. Namely, in the real world, the agent may be animate being (e.g., a person or animal) that makes a decision based on an environment. The agent makes active movement rather than or in addition to passive movement. An agent model, or an instance of an agent model may exist for each agent in a scenario. The agent model is a model of the agent. If the agent is in a mode of transportation, then the agent model includes the model of transportation in which the agent is located. For example, agent models may represent pedestrians, children, vehicles being driven by drivers, pets, bicycles, and other types of agents.

The agent model leverages the scenario specification and assets to control all agents in the scene and their actions at each time step. The agent's behavior is modeled in a region of interest centered around the autonomous system. Depending on the scenario specification, the agent simulation will control the agents in the simulation to achieve the desired behavior. Agents can be controlled in various ways. One option is to leverage heuristic agent models, such as an intelligent-driver model (IDM) that try to maintain a certain relative distance or time-to-collision (TTC) from a lead agent or heuristic-derived lane-change agent models. Another is to directly replay agent trajectories from a real log or to control the agent(s) with a data-driven traffic model. Through the configurable design, embodiments may mix and match different subsets of agents to be controlled by different behavior models. For example, far-away agents that initially may not interact with the autonomous system and can follow a real log trajectory, but when near the vicinity of the autonomous system may switch to a data-driven agent model. In another example, agents may be controlled by a heuristic or data-driven agent model that still conforms to the high-level route in a real-log. This mixed-reality simulation provides control and realism.

Further, agent models may be configured to be in cooperative or adversarial mode. In cooperative mode, the agent model models agents to act rationally in response to the state of the simulated environment. In adversarial mode, the agent model may model agents acting irrationally, such as exhibiting road rage and bad driving.

The agent models (118) are trained by an agent model trainer (142). The agent model trainer (142) is a software process that is configured to perform multiple agent training to train multiple agents concurrently. The agent model trainer is described in reference to FIG. 3.

The latency model (120) represents timing latency that occurs when the autonomous system is in a real-world environment. Several sources of timing latency may exist. For example, a latency may exist from the time that an event occurs to the sensors detecting the sensor information from the event and sending the sensor information to the virtual driver. Another latency may exist based on the difference between the computing hardware executing the virtual driver in the simulated environment as compared to the computing hardware of the virtual driver. Further, another timing latency may exist between the time that the virtual driver transmits an actuation signal to the autonomous system changing (e.g., direction or speed) based on the actuation signal. The latency model (120) models the various sources of timing latency.

Stated another way, in the real world, safety-critical decisions in the real world may involve fractions of a second affecting response time. The latency model simulates the exact timings and latency of different components of the onboard system. To enable scalable evaluation without strict requirements on exact hardware, the latencies and timings of the different components of the autonomous system and sensor modules are modeled while running on different computer hardware. The latency model may replay latencies recorded from previously collected real world data or have a data-driven neural network that infers latencies at each time step to match the hardware in a loop simulation setup.

The training data generator (122) is configured to generate training data. For example, the training data generator (122) may modify real-world scenarios to create new scenarios. The modification of real-world scenarios is referred to as mixed reality. For example, mixed-reality simulation may involve adding in new agents with novel behaviors, changing the behavior of one or more of the agents from the real-world, and modifying the sensor data in that region while keeping the remainder of the sensor data the same as the original log. In some cases, the training data generator (122) converts a benign scenario into a safety-critical scenario.

The simulator (100) is connected to a data repository (105). The data repository (105) is any type of storage unit or device that is configured to store data. The data repository (105) includes data gathered from the real world. For example, the data gathered from the real world include real agent trajectories (126), real sensor data (128), real trajectories of the system capturing the real world (130), and real latencies (132). Each of the real agent trajectories (126), real sensor data (128), real trajectory of the system capturing the real world (130), and real latencies (132) is data captured by or calculated directly from one or more sensors from the real world (e.g., in a real-world log). In other words, the data gathered from the real-world are actual events that happened in real life. For example, in the case that the autonomous system is a vehicle, the real-world data may be captured by a vehicle driving in the real world with sensor equipment.

Further, the data repository (105) includes functionality to store one or more scenario specifications (140). A scenario specification (140) specifies a scenario and evaluation setting for testing or training the autonomous system. For example, the scenario specification (140) may describe the initial state of the scene, such as the current state of the autonomous system (e.g., the full 6D pose, velocity and acceleration), the map information specifying the road layout, and the scene layout specifying the initial state of all the dynamic agents and objects in the scenario. The scenario specification may also include dynamic agent information describing how the dynamic agents in the scenario should evolve over time which are inputs to the agent models. The dynamic agent information may include route information for the agents, desired behaviors or aggressiveness. The scenario specification (140) may be specified by a user, programmatically generated using a domain-specification-language (DSL), procedurally generated with heuristics from a data-driven algorithm, or adversarial-based generated. The scenario specification (140) can also be conditioned on data collected from a real-world log, such as taking place on a specific real-world map or having a subset of agents defined by their original locations and trajectories.

The interfaces between the virtual driver and the simulator match the interfaces between the virtual driver and the autonomous system in the real world. For example, the sensor simulation model (114) and the virtual driver match the virtual driver interacting with the sensors in the real world. The virtual driver is the actual autonomy software that executes on the autonomous system. The simulated sensor data that is output by the sensor simulation model (114) may be in or converted to the exact message format that the virtual driver takes as input as if the virtual driver were in the real world, and the virtual driver can then run as a black box virtual driver with the simulated latencies incorporated for components that run sequentially. The virtual driver then outputs the exact same control representation that it uses to interface with the low-level controller on the real autonomous system. The autonomous system model (116) will then update the state of the autonomous system in the simulated environment. Thus, the various simulation models of the simulator (100) run in parallel asynchronously at their own frequencies to match the real-world setting.

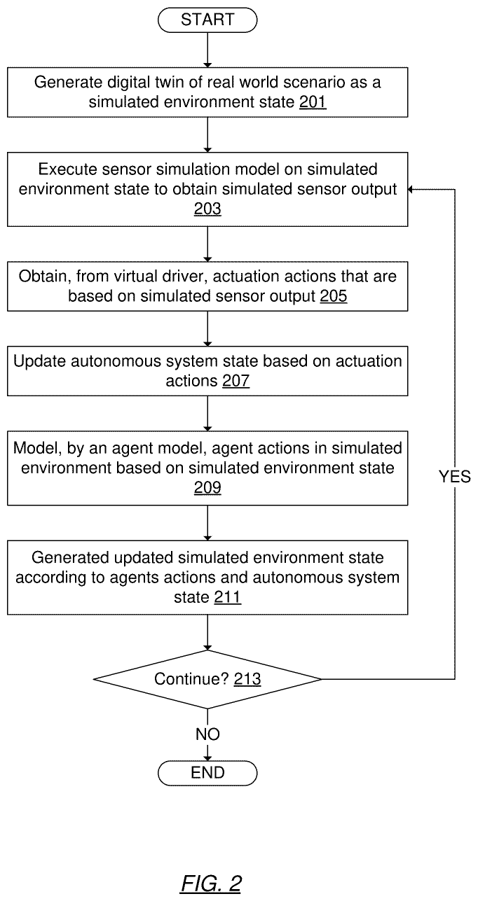

FIG. 2 shows a flow diagram for executing the simulator in a closed loop mode. In Block 201, a digital twin of a real-world scenario is generated as a simulated environment state. Log data from the real world is used to generate an initial virtual world. The log data defines which asset and agent models are used in the initial positioning of assets. For example, using convolutional neural networks on the log data, the various asset types within the real world may be identified. As other examples, offline perception systems and human annotations of log data may be used to identify asset types. Accordingly, corresponding asset and agent modes may be identified based on the asset types and add to the positions of the real agents and assets in the real world. Thus, the asset and agent models create an initial three-dimensional virtual world.

In Block 203, the sensor simulation model is executed on the simulated environment state to obtain simulated sensor output. The sensor simulation model may use beamforming and other techniques to replicate the view to the sensors of the autonomous system. Each sensor of the autonomous system has a corresponding sensor simulation model and a corresponding system. The sensor simulation model executes based on the position of the sensor within the virtual environment and generates simulated sensor output. The simulated sensor output is in the same form as would be received from a real sensor by the virtual driver. In one or more embodiments, Block 203 may be performed as shown in FIGS. 4-6 (described below) to generate camera output and lidar sensor output, respectively, for a virtual camera and a virtual lidar sensor, respectively. The operations of FIGS. 4-6 may be performed for each camera and lidar sensor on the autonomous system to simulate the output of the corresponding camera and lidar sensor. Location and viewing direction of the sensor with respect to the autonomous vehicle may be used to replicate the originating location of the corresponding virtual sensor on the simulated autonomous system. Thus, the various sensor inputs to the virtual driver match the combination of inputs if the virtual driver were in the real world.

The simulated sensor output is passed to the virtual driver. In Block 205, the virtual drive executes based on the simulated sensor output to generate actuation actions. The actuation actions define how the virtual driver controls the autonomous system. For example, for a self-driving vehicle, the actuation actions may be the amount of acceleration, movement of the steering, triggering of a turn signal, etc. From the actuation actions, the autonomous system state in the simulated environment is updated in Block 207. The actuation actions are used as input to the autonomous system model to determine the actual actions of the autonomous system. For example, the autonomous system dynamic model may use the actuation actions in addition to road and weather conditions to represent the resulting movement of the autonomous system. For example, in a wet or snowy environment, the same amount of acceleration action as in a dry environment may cause less acceleration than in the dry environment. As another example, the autonomous system model may account for possibly faulty tires (e.g., tire slippage), mechanical based latency, or other possible imperfections in the autonomous system.

In Block 209, agents' actions in the simulated environment are modeled, by the agent, based on the simulated environment state. Concurrently with the virtual driver model, the agent model and asset models are executed on the simulated environment state to determine an update for each of the assets and agents in the simulated environment. Through the training of the agent model described in the following Figures, the agent model causes the agent to take actions that are more realistic. For some of the agents, the agents' actions may use the previous output of the evaluator to test the virtual driver. For example, if the agent is adversarial, the evaluator may indicate based on the previous action of the virtual driver, the lowest scoring metric of the virtual driver. Using a mapping of metrics to actions of the agent model, the agent model executes to exploit or test that particular metric.

Thus, in Block 211, the simulated environment state is updated according to the agents' actions and the autonomous system state to generate an updated simulated environment state. The updated simulated environment includes the change in positions of the agents and the autonomous system. Because the models execute independently of the real world, the update may reflect a deviation from the real world. Thus, the autonomous system is tested with new scenarios. In Block 213, a determination is made whether to continue. If the determination is made to continue, testing of the autonomous system continues using the updated simulated environment state in Block 203. At each iteration, during training, the evaluator provides feedback to the virtual driver. Thus, the parameters of the virtual driver are updated to improve the performance of the virtual driver in a variety of scenarios. During testing, the evaluator is able to test using a variety of scenarios and patterns including edge cases that may be safety critical. Thus, one or more embodiments improve the virtual driver and increase the safety of the virtual driver in the real world.

As shown, the virtual driver of the autonomous system acts based on the scenario and the current learned parameters of the virtual driver. The simulator obtains the actions of the autonomous system and provides a reaction in the simulated environment to the virtual driver of the autonomous system. The evaluator evaluates the performance of the virtual driver and creates scenarios based on the performance. The process may continue as the autonomous system operates in the simulated environment.

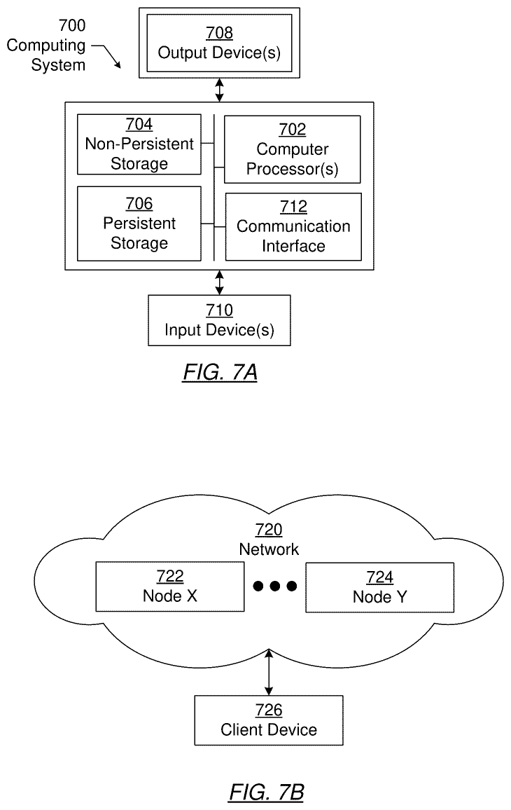

FIG. 3 shows a diagram of an agent model trainer (142) in accordance with one or more embodiments. The agent model trainer (142) is a software system configured to execute on the computing device shown in FIGS. 7A and 7B. As shown in FIG. 3, the agent model trainer (142) includes an imitation loss function (302), a reward function (304), a reinforcement leaning loss function (306), agent model updater (308), a scripted agent parameter (310), a scripted agent simulator (312), and a controller (314). Each of these components is described below.

The imitation loss function (302) is a function that computes imitation loss. Imitation loss is a difference between the real-world executing a real-world scenario and the virtual world executing the real-world scenario. In the real-world scenario, multiple agents move through a geographic region. Each agent moves along a trajectory. The trajectory may be defined as a sequence of states for the agent, whereby each state in the sequence has a corresponding timestep. The state may have at least a heading and a location. For example, the location and heading may be defined with respect to the geographic region. Sensors in the geographic region may capture the real-world scenario to obtain the real agent trajectories for the agents. When creating a digital twin of the real world, real agents have corresponding virtual agents in the virtual world. To simulate a real-world scenario, at the start of a simulation, the virtual agents are in the same initial state as the corresponding real agent. To simplify the description, the real agent and the corresponding virtual agent are both referred to as the agent. One skilled in the art having benefit of the disclosure will appreciate that although the singular agent is used, the agent in the virtual world is the virtualized form of the real-world agent.

In one or more embodiments, the imitation loss function estimates the amount of divergence of the policy of the agent model when performing actions of the virtual agent as compared to the policy of the corresponding real-world agent. The policy is the reasoning behind the decisions of the agent model or the expert in taking a particular trajectory. Because divergence between policies may be a challenge to quantify, the imitation loss function (302) may estimate the divergence using a distance function. For example, for an agent, the imitation loss function may be a function of the difference between the real and virtual trajectories of the agent.

The reward function (304) is a function that takes, as input, the trajectory of the agent and produces, as output, a reward value. In one or more embodiments, the reward function (304) calculates a reward value for each agent, individually. The reward function may be a sparse reward function. In one or more embodiments, sparse reward means the reward function is only non-zero upon reaching the terminal state of a Markov decision process (e.g., at the end of the simulation), which is the case here because the simulation ends if an agent collides or drives off the road. In one or more embodiments, the majority of agent states should be returning zero reward. In some embodiments, only a limited number of criteria is limited to a predefined threshold. By way of an example, the sparse reward function may have at most two criteria. The first criterion may be an anticollision criterion. An anticollision criterion penalizes trajectories that involve collisions with agents and other objects in the geographic region. Collisions may include near-collisions as defined by a predefined threshold. The second criterion may be a pathway deviation avoidance. For example, the pathway deviation avoidance is that the trajectory does not deviate from the path as demarcated in a map of the geographic region. For example, the path may be the roadway in the case of vehicle traffic or an airway in the case of aviation traffic. Dense reward, which would have almost all states returning non-zero reward, may also be used.

The reinforcement learning loss function (306) is configured to calculate a reinforcement learning loss. In one or more embodiments, the reinforcement learning loss is based on the value of the reward function. In one or more embodiments, the reinforcement learning loss is accumulated across the agents.

The agent model updater (308) is configured to calculate a total loss from the output of the imitation loss function (302) and the reinforcement learning loss function (306). The agent model updater (308) is further configured to backpropagate the total loss through the agent model (118) to update the agent model (118).

Continuing with FIG. 3, the agent model trainer (142) includes scripted agent parameters (310). Scripted agent parameters (310) are parameters of a scripted agent. A scripted agent is an agent that has a modified behavioral characteristic from the real world. As such, the scripted agent is designed to deviate from a real-world agent. For example, the scripted agent may be configured to instigate a dangerous situation in the virtual scenario. In the case of vehicular traffic, the modified behavioral characteristic may be that the scripted agent cuts off another agent, weaves, breaks quickly, or perform other actions that deviate from the real-world scenario. The scripted agent parameters (310) define the range of the behavioral modification. For example, the scripted agent parameters may specify a range of the amount of the cutoff (e.g., the distance between the scripted agent and the other agent), a range of speeds that are greater than the speed limit, a range of deceleration amounts, etc.

The scripted agent simulator (312) is configured to implement the scripted agent parameters (312). Specifically, the scripted agent simulator (312) may be configured to sample the scripted agent parameters (312) and set the state of the agent for the timesteps according to the sampled scripted agent parameters. The scripted agent simulator (312) may use the agent model (118) or a different model as a basis from which to perform the modification.

The controller (314) is configured to control the training of the agent model. In particular, the controller (314) is configured to initiate the execution of a scenario and trigger the execution of the agent model (118) for the agents in the scenario. The controller (314) may also be configured to trigger the calculation of the loss. Thus, the controller (314) controls the training of the agent model (118).

FIG. 4 shows a diagram of the agent model (400) in accordance with one or more embodiments of the invention. The agent model (400) in FIG. 4 is an example of the agent model (118) in FIG. 3 and FIG. 1. Other agent models may be used without departing from the scope of the claims. The agent model (400) is connected to a map data repository (402) and one or more agent states (404). The map data repository (408) is configured to store map data. Map data is data describing the map of the geographic region. The map data identifies types, positions, and other attributes of map elements in the geographic region. Map elements are physical portions of the geographical region that may be reflected in a map of the geographic region. For example, the map elements may be a curb, a particular lane marker, a particular location between two lane markers or a lane marker and a curb, a light, a stop sign, or a construction zone, or other physical object/location in the geographic region. The map elements may or may not be demarcated in the real world. For example, if the map element is a particular spot in the real world that is between two lane markers, the particular spot exists in the real world and has a physical location, but the particular spot may not have any signposts or other markings in the real world that are at the particular spot. In one or more embodiments, a map of the geographic region directly or indirectly specifies the stationary locations of the map elements.

The agent states (404) are the current states of the agents in the geographic region. The agent states are the states described above with reference to FIG. 3. For example, the agent states (404) may be the coordinates of the agents and heading.

The agent model (400) may include a map encoder model (408), an agent encoder model (410), a concatenator (412), a combined encoder model (414), and a decoder model (416) in accordance with one or more embodiments.

The map encoder model (408) is a software process configured to encode map elements of a geographic region as relative positions with respect to each other. Specifically, the map encoder model (408) may be configured to calculate, for each map element, the relative position of the map element with respect to other map elements in the geographic region. Thus, for each map element, a set of relative positions of the map element with respect to other map elements may be defined. The map encoder model (408) may be further configured to encode the relative positions into a feature set for a pair of map elements. Additionally, a map element may have a feature set defining the map element. For example, the feature set may encode size information, the type of geographic region in which the map element is located (e.g., urban, rural, etc.), type of map element, and other features about the map element or the properties surrounding the map element.

The output of the map encoder model (408) may be map element encodings in a map layer of the heterogeneous graph. The map layer is a graph data structure having a map element nodes connected by edges. The map element node is for an individual corresponding map element. The edges connecting two map element nodes may be associated with a relative position encoding of the corresponding pair of map element nodes. The map element node may be associated with a feature set that is generated based on general features of the map element. Prior to outputting, the map encoder model (410) may include a graph neural network that is configured to process the feature sets of the map element nodes based on connected feature sets to obtain an updated feature set for each map element node.

The agent encoder model (410) may further be configured to calculate, for each agent, the relative current position of the agent with respect to past positions of the agent. The relative position encoding is a set of relative positions for an agent that specify the position of the agent in terms that are relative to other agents. In one or more embodiments, the relative position is defined by the distance between the two agents (e.g., the agent and another agent or the agent and itself in a previous time) and the angle between the headings of the agents. The agent encoder model (410) may be further configured to encode, in agent position encodings, the relative positions of the agent into a feature set for the agent in one or more embodiments.

The output of the agent encoder model (410) may be agent position encodings in an agent layer of a heterogeneous graph. The agent layer is a graph data structure having agent nodes connected by edges. An agent node is for an individual corresponding agent. The agent node may have an attribute of a feature set defining general features of the agent. The edge connecting two agent nodes may be an agent position encoding that is generated by encoding of the relative positions of the corresponding two agents represented by the agent nodes. The agent position encoding encodes the relative position of the agent. The relative current position of the agent with respect to past positions of the agent may be based encoded in the agent node or in an edge connecting an agent node to itself. Prior to outputting, the agent encoder model (410) may include a graph neural network that is configured to process the feature sets of the agent nodes based on connected feature sets to obtain an updated feature set for each agent node.

The concatenator (412) is a software process configured to generate a heterogeneous graph data structure from the output of the map encoder model (408) and the agent encoder model (410). In one or more embodiments, the concatenator (412) is configured to add, to the agent layer and the map element layer, a set of edges connecting agent nodes to map element nodes to generate the heterogeneous graph. The edges may be added based on the adjacency between agent nodes and map element nodes. For example, for each agent node, an edge may be added between the agent node and the map element nodes that are adjacent to the agent node. Adjacency may be defined, for example, based on distance or based on degrees from heading direction.

The concatenator (412) is connected to a combined encoder model (414). The combined encoder model (414) may be a graph neural network. The combined encoder model (416) is further configured to update the heterogeneous graph to encode the overall scene. For example, the updating of the heterogeneous graph may be to pass messages between the nodes (e.g., map element nodes and agent nodes) and edges to encode the overall scene (e.g., the map, agents, and historical trajectories of agents). The features associated with an edge may be updated to reflect the features of other edges.

A decoder model (416) is a software process configured to model agent actions using the heterogenous graph and generate one or more updated agent states. The agent action is an action that an agent may perform given the overall scene. In one or more embodiments, the decoder model (416) generates parameters defining agent action for the timestep based on the overall scene. The parameters explicitly or implicitly define a new starting state for each of the agents for the next timestep based on the overall scene. For example, the parameters may be the new state directly. As another example, the parameters may be acceleration and direction for the next timestep. If acceleration and direction are generated, the agent model (400) may further include a bicycle model or other such model that defines the new state based on the parameters. The decoder model (416) may further include a benefit value decoder. The benefit value decoder may include a multilayer perceptron model. The benefit value decoder generates a benefit value of performing the agent action. The benefit value of a state represents the expected discounted cumulative reward the policy is expected to receive if the agent were in that state.

In one or more embodiments, the decoder model (416) outputs the parameters and the benefit value for each agent in the geographic region. A single decoder model may be for all agents, a strict subset of agents, or for each individual agent.

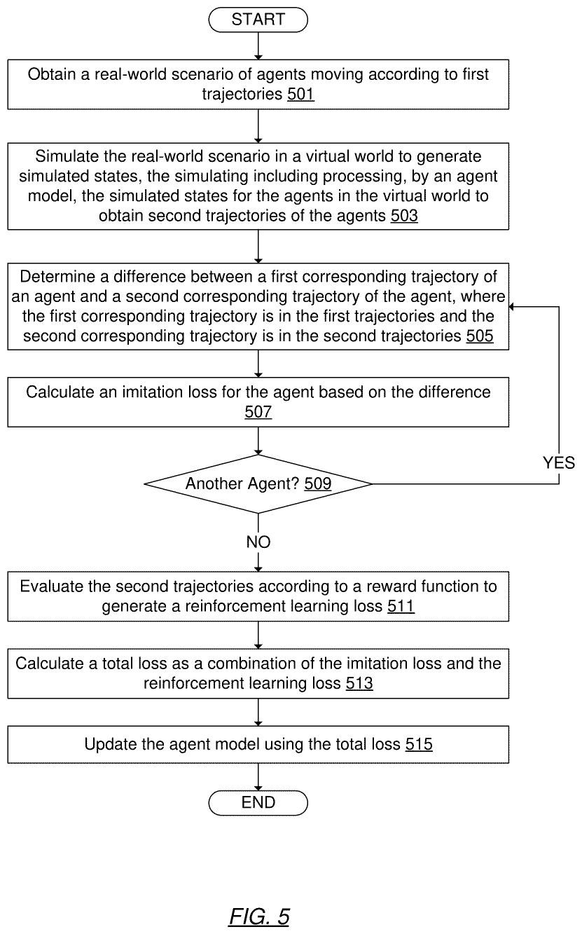

FIG. 5 shows a flowchart in accordance with one or more embodiments. For FIG. 5, the virtual driver and the autonomous system is not part of the simulation. In Block 501, a real-world scenario of agents moving according to first trajectories is obtained. The real-world scenario may be obtained from storage. In one or more embodiments, to populate the storage, a sensing system with various sensors moves through the real-world. For example, the sensing system may be a sensing vehicle that moves through the real world. In another scenario, the sensing system is a set of sensors may be distributed in the real world that together cover the geographic region. The sensing system gathers sensor data, such as LiDAR and camera images, which are then converted into two-dimensional birds-eye-views or three-dimensional models of the real-world. The conversion is based on the position of the sensor in the geographic region and the determined distance to the various objects, including agents, at each time that the sensor values in the sensor data is acquired. The result of processing in FIG. 5 is a real-world trajectory for each of the agents in one or more embodiments. The real-world trajectory may be specified as a series of states of the agent.

In Block 503, the real-world scenario is simulated in a virtual world to generate simulated states, whereby the simulating including processing, by an agent model, the simulated states for the agents in the virtual world to obtain second trajectories of the agents. The simulation system attempts to imitate the real-world. At the start of the simulation, agents are added to the geographic region at locations matching respective initial locations of the agents in the real-world. To perform the simulation, the agent model executes for each of multiple timesteps to obtain, for each agent, a new state of the agent for the timestep.

The manner of executing the agent model is dependent on the type of agent model. For the agent model of FIG. 4, the following operations may be performed. The map encoding model may generate a map layer having map element nodes for the map elements of the geographic region. The map encoding model connects the map element nodes in the map layer by edges based on relative positions between the map elements. The map encoding model may the process the map layer through a graphical neural network to generate map element encodings for the map element nodes. In one or more embodiments, the graph neural network updates the map element encodings without removing or adding nodes. Thus, each map element keeps the corresponding map element nodes. The processing of the map encoder model may be performed once for the geographic region. The agent encoder model generates agent nodes for the agents in an agent layer. The agent nodes are connected in the agent layer by edges identifying relative positions of the agents with respect to each other. Each agent node may also be connected to or are encoded with a historical position of the agent at a previous time. The agent encoder model may process the agent layer through a graph neural network that generates an agent encoding that encodes the relative historical positions of the corresponding agent with respect to a current position of the corresponding agent and that encodes the agent with respect to other agents. As with the map encoding model, the graph neural network of the agent encoding model does not add or remove nodes from the agent layer in one or more embodiments. The concatenator connects the agent layer to the map element layer based on the relative positions of the agent nodes with respect the map element nodes. In one or more embodiments, agent nodes are connected to the closest map element node in each of preset directions. The resulting connection of the agent layer to the map element layer is a heterogeneous graph that may be processed through a graph neural network to generate an interaction encoding for each of the agent nodes.

For a particular agent, the decoder model uses the agent node to generate an updated state for a next timestep. The decoder model may be a multilayer perceptron (MLP) model that processes the agent encoding through one or more layers of a neural network to generate output. For example, the decoder model may output an agent action for the agent. The agent action may be specified as a heading and an acceleration. Using kinematic equations, such as through a bicycle model, the new state of the agent may be determined. As another example, the decoder model may directly output a predicted state. In addition to the updated state for the next timestep, the decoder model may also output a probability. The probability may be the likelihood of the decoder model transitioning to the updated state. A benefit value decoder may also process the agent encoding to generate a benefit value of performing the agent action for the current timestep. The decoder model processes each agent node in the scene to determine updated states for the agents. The updated states are added to the trajectories for the agents. The updated states are also used to revise the agent layer (or generate a new agent layer). For example, a new agent layer may be created. The operations described in above for Block 503 may be performed for each of multiple timesteps in the trajectory to generate a trajectory of each of the agents. For example, the operations may be performed for a five second block whereby timesteps are 3 milliseconds. In one or more embodiments, a result of processing of Block 503 is an estimated trajectory for each of the agents, whereby each estimated trajectory has multiple states for the agent. In one or more embodiments, the processing of Block 503 is closed loop, and without human interaction. For example, the agent model may determine the trajectories without input from other systems.

The following may be performed on a per agent basis for each of at least a subset of agents to generate an imitation loss for the agent. In Block 505, a difference between a first corresponding trajectory of an agent and a second corresponding trajectory of the agent is calculated. The first trajectory is the real-world trajectory from Block 501 and the second trajectory is the predicted trajectory from Block 503. Various mechanisms may be used to calculate the difference between the trajectories. For each state in the first trajectory and corresponding state in the second trajectory, the distance between the positions in the state may be calculated and, optionally, the difference in the angles of the heading directions may be determined to generate a result. The results across the multiple states may be combined to generate an aggregated difference for the agent. For example, the combination may be summation of the differences or averaging of the differences.

In Block 507, an imitation loss is determined for the agent. In one or more embodiments, the imitation loss is directly the difference calculated in Block 505. In other embodiments, the imitation loss is a function of the difference.

In Block 509, a determination is made whether another agent exists for which the imitation loss is not yet determined. If another agent exists, the processing continues with Block 505. Blocks 505 and 507 may be performed for each of at least a subset of the agents in parallel. For example, the processing may be performed for all agents or just a portion of the agents. In one or more embodiments, the imitation loss is determined on a per agent basis. Thus, each agent may have a corresponding imitation loss.

In Block 511, the second trajectories determined from simulation are evaluated according to a reward function to generate a reinforcement learning loss. To evaluate the second trajectories, the following may be performed for each of the agents. The reward function may be calculated individually for each of the timesteps along the trajectory to generate multiple reward values for the agent. The reward function may be a predefined reward function that rewards certain traffic behavior. For example, the reward function may be a function of the difference between the trajectory of the agent and the map elements, the speed of the agent as determined from the trajectory, whether the agent stays on road, etc. An advantage function may be calculated for the agent from the reward values. The advantage function may be a generalized estimated advantage that uses as input the reward values and the benefit values generated by the benefit decoder model to generate an advantage value. Because the advantage value uses the reward function, the advantage value gives a higher value to trajectories that satisfy the reward function (e.g., exhibit a behavior of agents that embodiments want to reward rather than just imitating the real world). The advantage value is on a per agent basis.

A policy loss is calculated across the agents using the using the advantage value for each agent of the at least the subset of agents. To calculate a policy loss, the following operations may be performed to generate an intermediate value. A ration of a current probability for performing the trajectory to a historical probability of performing the trajectory is determined. The current probability is the probability of the agent model performing an action of the trajectory under the current agent model. The historical probability is the probability of the agent model performing the action prior to a previous update of the agent model. For example, the simulation of Block 503 may be performed for the current agent model, and the immediately preceding model without the previous update to the agent model. Because the agent model, with and without the update, may output a probability for each action in the trajectory, the probabilities may be obtained from the agent models and accumulated across the states for the agent. The ratio may be restricted to minimize the amount of change due to a particular agent. Thus, the result is limiting the policy loss. The ration may be multiplied by the advantage value to an intermediate value for the agent. The intermediate values may then be summed across the agents to generate the policy loss.

The reinforcement learning loss is calculated from the policy loss. The reinforcement learning loss may be a combination of the policy loss and a benefit loss. The benefit loss is calculated as, the summation across the agents, of the difference between the benefit value output by the decoder model and an estimated benefit value calculated from the reward function. The reinforcement learning loss may be the addition of the policy loss and the benefit loss.

The above is only one example of calculating a reinforcement learning loss from the reward value. Other techniques may be used without departing from the scope of the claims.

Continuing with FIG. 5, in Block 513, a total loss is calculated as a combination of the imitation loss and the reinforcement learning loss. For example, the total loss may be the sum of the imitation loss and the reinforcement learning loss.

In Block 515, the agent model is updated using the total loss. In one or more embodiments, updating the agent model includes backpropagating the total loss through agent model, including the graph neural network of the agent model and the decoder model. The result is that the parameters and weights of the decoder model and the graph neural networks are update.

In some embodiments, the simulation is performed on synthetic data rather than on sensor data to generate additional scenarios that do not knowingly exist in the real world. For example, in one or more embodiments, a behavior characteristic of an agent is modified to obtain a scripted agent. The agent may be an existing agent in a scenario for which real world data is collected (e.g., in Block 501 of FIG. 5.) As another example, the agent may be a new agent. The modification may be to define a range of speeds of the agent, to specify that the agent cuts off or otherwise makes an unsafe change in lanes, stops quickly, moves erratically, etc. The modification may be received from a human or another system, for example, and may be received as a range for the behavior. For example, the range may be an amount of space between the agent being cutoff and the scripted agent, the range of speeds of the agent, etc. Thus, the scripted agent is an agent with a modified behavior characteristic. Modified here means that the scripted agent does not have a behavior characteristic determined from the agent model.

A scenario with the scripted agent (i.e., synthetic scenario) is simulated in the virtual world to generate simulated states for the agents in the scenario. The simulation includes using the agent model for agents that exclude the scripted agent in the scenario. Concurrently, the scripted agent trajectory of the scripted agent is determined according to the modified behavior characteristic. The scripted agent moves along the scripted agent trajectory according to the script and the other agents react to the scripted agent and to each other using the agent model. The processing of the scripted agent and the agent model is performed over multiple timesteps. For each timestep, the simulation of the scripted agent outputs a next state for the scripted agent and the agent model generates a next state for the remaining agents using the technique of Block 503. The result is a set of trajectories for the agents that are generated by the agent model.

The set of trajectories for the agents that exclude the scripted agent is evaluated according to the reward function to generate a reinforcement learning loss, which is then used to update the agent model. The generation of the reinforcement learning loss and updating of the agent model may be performed as described above with reference to Block 511 and 515 of FIG. 5.

The processing of FIG. 5 may be repeated over the course of several real world and modified scenarios to iteratively train the agent model. When the training completes, the agent model both reflects the real world and the desired rewards.

As discuss above, one use of the trained agent model is to train a virtual driver of an autonomous system. For example, the virtual driver may be trained by simulating a scenario to obtain a simulation result. To simulate the scenario, a simulated environment state is generated. Initially, the simulated environment is the initial placement of the agents and the autonomous system. The virtual driver outputs an actuation action that that is based on the simulated environment state. The actuation action is used to update the autonomous system state in the simulation. The agent model models the agent action for each of the agents. Namely, the trained agent model generates a state for each of the agents, for example, using the technique described above with reference to Block 503 of FIG. 5. The updated simulated environment state is generated that includes the agent actions and the autonomous system action. The process is iteratively performed over a series of timesteps to generate a trajectory for the autonomous system and each of the agents. The trajectories are evaluated using various criteria to generate a loss for the virtual driver. The virtual driver is then trained based on the simulation result. Because the agent model is more accurate, the training of the virtual driver is improved. Thus, when deployed to the real world, the virtual driver may have improved driving of the autonomous system.

The following description are for explanatory purposes only and not intended to limit the scope of the claims. Specifically, the example below is an example implementation that may be used. Embodiments of the invention may depart from the example implementation without departing from the scope of the claims. In the following example consider the scenario in which the agents are vehicles driving on roadways.

Simulation is an important component to safely developing autonomous vehicles. Designing realistic traffic agents is used to build high-fidelity simulation systems that have a low domain gap to the real world. However, this can be challenging as the idiosyncratic nature of human-like driving should be captured along with avoiding unrealistic traffic infractions like collisions or driving off-road. Imitation learning (IL) may be performed whereby nominal human driving data is used as expert supervision to train the agents. In imitation learning, regardless of whether the humans are driving well, the humans are considered the experts with respect to training the agents. While expert demonstrations provide supervision for human-like driving, pure imitation learning do not have explicit knowledge of traffic rules and infractions, which can result in unrealistic policies. Furthermore, the reliance on expert demonstrations can be a disadvantage, as long-tail scenarios with rich interactions are very rare, and thus learning is overwhelmingly dominated by more common scenarios with a much weaker learning signal.

Reinforcement learning (RL) approaches encode explicit knowledge of traffic rules through hand-designed rewards that penalize infractions. Pure reinforcement learning learns to maximize traffic-compliance rewards through trial and error. In the context of autonomy, reinforcement learning allows training on synthetic scenarios that do not have expert demonstrations. However, traffic rules alone cannot describe all the nuances of human-like driving.

One or more embodiments is trained in closed-loop to match expert demonstrations under a traffic compliance constraint using both nominal offline data and simulated long-tail scenarios (i.e., synthetic scenarios) as a rich learning environment. This gives rise to an IL objective which supervises the policy using real-world expert demonstrations and an RL objective which explicitly penalizes infractions.

The closed-loop approach may allow the agent model to understand the effects of the agent model's actions and may suffer significantly less from compounding error. Exploiting simulated long-tail scenarios may improve learning by exposing the policy to more interesting interactions that would be difficult and possibly dangerous to collect from the real world at scale.

In the following, multi-agent traffic simulation is modeled as a Markov Decision Process [symbol] =( [symbol] R, P, γ) with state space, action space, reward function, transition dynamics, and discount factor, respectively. The following uses a fully observable and centralized multi-agent formulation where a single agent model jointly controls all agents.

The state s={s⁽¹⁾, . . . , s^{(N)}, m}∈ [symbol] is the joint states of N agents where N may vary across different scenarios. The system also has a high definition (HD) map m, which captures the road and lane topology. The state of the i-th agent s⁽ⁱ⁾ is parameterized with its position, heading, and velocity over the past H history timesteps. The state also captures 2D bounding boxes for each agent. Likewise, a={a⁽¹⁾, . . . , a^{(N)}}∈ [symbol] is the joint action which contains the actions taken by all the agents. The i-th agent's action a⁽ⁱ⁾ is parameterized by its acceleration and steering angle. Agents are controlled by a single centralized policy π(a|s) which maps the joint state to joint action.

A trajectory τ_{0:T}=(s₀, a₀, . . . , S_{T-1}, a_{T-1}, S_{T}) is defined as a sequence of state action transitions of length T for all agents. The kinematic bicycle model may be used as a model of transition dynamics P(sₜ₊₁|sₜ, aₜ) for each agent. Trajectories may be sampled by first sampling from some initial state distribution ρ₀ before unrolling a policy w through the transition dynamics, P^{π}(τ)=ρ₀(s₀)Πₜ₌₀^{T-1}π(aₜ|sₜ)P(sₜ₊₁|sₜ, aₜ).

For reward, let R⁽ⁱ⁾(s, a⁽ⁱ⁾) be a per-agent reward which is specific for the i-th agent, but dependent on the state of all agents, to model interactions such as collision. The joint reward is then R(s, a)=Σᵢ^{N}R⁽ⁱ⁾(s, a⁽ⁱ⁾), with R(τ)=Σₜ₌₀^{T-1}γ^{t}R(sₜ, aₜ) as the γ-discounted return of a trajectory.

For policy learning of the agent model, both IL and RL can be described in this framework. IL can be described as an f-divergence minimization problem: π*=arg min_{π}D_{f}(P^{π}(τ)∥P^{E}(τ)) where P^{E} is the expert-induced distribution. RL aims to find the policy which maximizes the expected reward π*=arg max_{π} [symbol] ₚπ[R(τ)].

To learn a multiagent traffic policy that is as human-like as possible while avoiding infractions, one or more embodiments consider the reverse Kullback-Leibler (KL) divergence to the expert distribution with an infraction-based constraint:

$$\begin{matrix}arg {min}_{π} & {D}_{KL} ( {P}^{π} ( τ ) ‖ {P}^{E} ( τ ) ) \\ s . t . & {𝔼}_{{P}^{π}} [ R ( τ ) ] \geq 0\end{matrix} \qquad ( 1 )$$

$${R}^{( i )} ( s , {a}^{( i )} ) = \{ \begin{matrix}- 1 & if infraction \\ 0 & otherwise\end{matrix} , \qquad ( 2 )$$

where R⁽ⁱ⁾ is a per-agent reward function that penalizes any infractions (collision and off-road events). For a rich learning environment, both a dataset D of nominal expert trajectories τ^{E}˜P^{E} collected by driving in the real world, and additional simulated long-tail scenarios are used. Unlike real world logs, the long-tail scenarios use scripted agents, which induce interesting interactions like sudden cut-ins, etc. More precisely, let π_{θ} be the agent model policy. Let s₀^{s}˜ρ₀^{s} be the initial state sampled from the long-tail distribution and no represent the policy of the scripted agent. The overall multiagent policy may be given as

$$π ( {a}_{i , t} \vert {s}_{t} ) = \{ \begin{matrix}{π}_{{s}_{0}}^{S} ( {a}_{t}^{( i )} \vert {s}_{t} ) & if agent is scripted \\ {π}_{θ} ( {a}_{t}^{( i )} \vert {s}_{t} ) & otherwise\end{matrix} . \qquad ( 3 )$$

The overall initial state distribution may then be given as ρ₀=(1−α)ρ₀^{D}+αρ₀^{s}, where ρ₀^{D} corresponds to the offline nominal distribution, and αΣ[0,1] is a hyperparameter that balances the mixture.

Taking the Lagrangian decomposes the objective into an IL and RL component,

$$ℒ = {𝔼}_{{P}^{π}} [ {\underbrace{- log {P}^{E} ( τ )}}_{IL} - λ {\underbrace{R ( τ )}}_{RL} ] - H ( π ) = {ℒ}^{IL} + {λℒ}^{RL} - H ( π ) \qquad ( 4 )$$

where λ is a hyperparameter balancing the two terms, and H(π) is an additional entropy regularization term. The IL and RL are optimized jointly in a closed-loop manner, as the expectation is taken with respect to the on-policy distribution P^{π}(τ). Compared to open-loop behavior cloning, the closed-loop IL component allows the model to experience states induced by its own policy rather than only the expert distribution, increasing its robustness to distribution shift. Furthermore, while the additional reward constraint may not change the optimal solution of the unconstrained problem (the expert distribution may be infraction-free), the closed loop can provide additional learning signal through RL.

The RL component [symbol] ₚπ[R(τ)] can be optimized using RL techniques and exploits both offline-collected nominal scenarios and simulated long-tail scenarios containing rich interactions. The imitation component [symbol] ^{IL} is only well-defined when expert demonstrations are available and thus only applied to nominal data.

One or more embodiments start from an initial state s₀^{E}˜ρ₀^{D} and have the policy π_{θ} control all agents in closed-loop simulation. The loss is the distance between the ground truth and policy-induced trajectory.

$${ℒ}^{IL} = {𝔼}_{{τ}^{E} \sim D} [ {𝔼}_{τ \sim {P}^{π} ( \cdot \vert {s}_{0}^{E} )} [ D ( {τ}^{E} , τ ) ] ] . \qquad ( 5 )$$

Because it may be difficult to obtain accurate action labels for human driving data in practice, states only may be used in the loss as follows D(τ^{E}, τ)=Σₜ₌₁^{T}d(sₜ^{E}, sₜ) where d is a distance function.

To optimize Equation 4, the [symbol] ^{IL} component is notably differentiable by using the reparameterization trick when sampling from the policy and differentiating through the transition dynamics (kinematic bicycle model).

To optimize the [symbol] ^{RL} component, one or more embodiments design a centralized and fully observable variant of Proximal Policy Optimization (PPO). While it is possible to directly optimize the policy with the overall scene reward R(s, a)=Σᵢ₌₁^{N}R⁽ⁱ⁾(s, a⁽ⁱ⁾), one or more embodiments instead optimize each agent individually with their respective individual reward Rᵢ(s, aᵢ). While the factorized approach may ignore second-order interaction effects, the factorized approach simplifies the credit assignment problem leading to more efficient learning.

To compute [symbol] ^{RL} component, the following procedure may be performed. A per-agent probability ratio is computed using the following equation.

$${r}^{( i )} = \frac{π ( {a}^{( i )} \vert s )}{{π}_{old} ( {a}^{( i )} \vert s )} . \qquad ( 6 )$$

Our centralized value-function uses the same architecture as our policy, and computes per-agent value estimates \hat{V}⁽ⁱ⁾(s). The value model is trained using per-agent value targets, which are computed with per-agent rewards Rₜ⁽ⁱ⁾=R⁽ⁱ⁾(sₜ, aₜ⁽ⁱ⁾)

$${ℒ}^{value} = {\sum }_{i}^{N} {( {\hat{V}}^{( i )} - {V}^{( i )} )}^{2} \qquad ( 7 )$$

$${V}^{( i )} = {\sum }_{t = 0}^{T} {γ}^{t} {R}_{t}^{( i )} \qquad ( 8 )$$

A per-agent generalized adversarial estimation (GAE) using the value model as well,

$${A}^{( i )} = GAE ( {R}_{0}^{( i )} , … , {R}_{T - 1}^{( i )} , {\hat{V}}^{( i )} ( {s}_{T} ) ) \qquad ( 9 )$$

The PPO policy loss may be simply the sum of per-agent PPO loss,

$${ℒ}^{policy} = {\sum }_{i = 1}^{N} min ( {r}^{( i )} {A}^{( i )} , clip ( {r}^{( i )} , 1 - ϵ , 1 + ϵ ) {A}^{( i )} ) \qquad ( 10 )$$

Finally, the overall [symbol] ^{RL} loss may be the sum of the policy and value learning

$${ℒ}^{RL} = {ℒ}^{policy} + {ℒ}^{value} \qquad ( 11 )$$

The RL loss and the IL loss may then be used to train the agent model.

The example implementation of the agent model may be as follows. The value network architecture may be the same, but regresses value targets instead. The agent model π_{θ} architecture may extract context and map features and predict agent actions. From each agent's state history, a shared 1D convolutional neural network (CNN) and gated recurrent unit (GRU) may be used to extract agent history context features hₐ⁽ⁱ⁾=f(s⁽ⁱ⁾). Concurrently, a graphical neural network (GNN) may be used to extract map features from a lane graph representation of the map input hₘ=g(m). A Heterogeneous graph neural network may then be used to jointly fuses all agent context features and map features before a shared MLP decodes actions for each agent independently.

$$\{ {h}^{( 1 )} , … {h}^{( N )} \} = HeteroGNN ( \{ {h}_{a}^{( 1 )} , … , {h}_{a}^{( N )} \} , {h}_{m} ) \qquad ( 6 )$$

$$( {μ}^{( i )} , {σ}^{( i )} ) = MLP ( {h}^{( i )} ) . \qquad ( 7 )$$

Independent normal distributions may be used to represent the joint agent policy, π(a⁽ⁱ⁾|s)= [symbol] (μ⁽ⁱ⁾, σ⁽ⁱ⁾), and thus π(a|s)=Πᵢ₌₁^{N}π(a⁽ⁱ⁾|s). Note that agents are only independent conditional on their shared past context, and thus interactive reasoning is still captured. The value model that generates the benefit value may use the same architecture but does not share parameters with the agent model that generates the states. The value model may compute {h₀^{ν}, . . . , h_{N}^{ν}} in a similar fashion and the benefit decoder model may decode per-agent value estimates \hat{V}⁽ⁱ⁾=MLP^{ν}(h⁽ⁱ⁾).

Nominal driving logs can be monotonous and provide weak learning signal when repeatedly used for training. Many traffic infractions can be attributed to rare and long-tail scenarios belonging to a handful of scenario families, which can be difficult and dangerous to collect from the real world at scale. Thus, long-tail scenarios may be procedurally generated to supplement nominal logs for training and testing. Following the self-driving industry standard, logical scenarios vary in the behavioral patterns of particular scripted agents with respect to an autonomous system agent (e.g., cut-in, hard-braking, merging, etc.). Each logical scenario may be parameterized by θ∈Θ which controls lower-level aspects of the synthetic scenario such as behavioral characteristics of the scripted agent (e.g., time-to-collision or distance triggers, aggressiveness, etc.), exact initial placement and kinematic states, and geolocation. A concrete synthetic scenario can then be procedurally generated in an automated fashion by sampling a logical scenario and corresponding parameters θ. While these synthetic scenarios cannot be used for imitation as the synthetic scenarios are simulated and do not have associated human demonstrations, the synthetic scenarios may provide a rich reinforcement learning signal due to the interesting and rare interactions induced by the scripted agents.

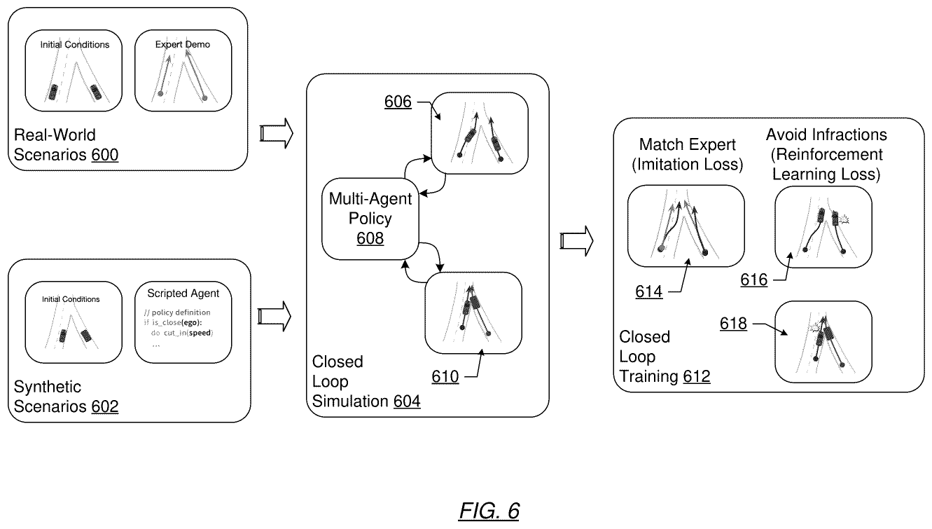

FIG. 6 shows an example for training the agent model in accordance with one or more embodiments. The example is for explanatory purposes only and not intended to limit the scope of the invention. As shown in FIG. 6, real-world scenarios (600) use a set of initial conditions and an expert demonstration. The expert may be a standard human driver, without specialized training. Further, the system may use synthetic scenarios (602) that have the set of initial conditions and a scripted agent.

Both scenarios are processed through closed loop simulation (604). Specifically, real-world scenarios (606) are iteratively processed by a multi-agent policy (i.e., implemented as the agent model) (608). The multi-agent policy is the behavior of each of the agents as defined by the agent model. Similarly, synthetic scenarios (610) are iteratively processed through the multi-agent policy (608).

From the results of the closed loop simulation, closed loop training (612) is performed of the multi-agent policy to generate an updated agent model. For the real-world scenarios, imitation loss is calculated by comparing the results of the closed loop simulation to the expert (614). Reinforcement learning loss is performed for both real world scenarios (616) and for synthetic scenarios (618). Thus, for real-world scenarios, the total loss is the combination of imitation loss and reinforcement learning loss. For synthetic scenarios, the total loss is the reinforcement learning loss. The total loss may be backpropagated through the agent model to iteratively improve the multi-agent policy of the agent model.

Embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure. For example, as shown in FIG. 7A, the computing system (700) may include one or more computer processors (702), non-persistent storage (704), persistent storage (706), a communication interface (712) (e.g., Bluetooth interface, infrared interface, network interface, optical interface, etc.), and numerous other elements and functionalities that implement the features and elements of the disclosure. The computer processor(s) (702) may be an integrated circuit for processing instructions. The computer processor(s) may be one or more cores or micro-cores of a processor. The computer processor(s) (702) includes one or more processors. The one or more processors may include a central processing unit (CPU), a graphics processing unit (GPU), a tensor processing unit (TPU), combinations thereof, etc.

The input devices (710) may include a touchscreen, keyboard, mouse, microphone, touchpad, electronic pen, or any other type of input device. The input devices (710) may receive inputs from a user that are responsive to data and messages presented by the output devices (708). The inputs may include text input, audio input, video input, etc., which may be processed and transmitted by the computing system (700) in accordance with the disclosure. The communication interface (712) may include an integrated circuit for connecting the computing system (700) to a network (not shown) (e.g., a local area network (LAN), a wide area network (WAN) such as the Internet, mobile network, or any other type of network) and/or to another device, such as another computing device.

Further, the output devices (708) may include a display device, a printer, external storage, or any other output device. One or more of the output devices may be the same or different from the input device(s). The input and output device(s) may be locally or remotely connected to the computer processor(s) (702). Many different types of computing systems exist, and the aforementioned input and output device(s) may take other forms. The output devices (708) may display data and messages that are transmitted and received by the computing system (700). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a storage device, a diskette, a tape, flash memory, physical memory, or any other computer readable storage medium. Specifically, the software instructions may correspond to computer readable program code that, when executed by a processor(s), is configured to perform one or more embodiments, which may include transmitting, receiving, presenting, and displaying data and messages described in the other figures of the disclosure.

The computing system (700) in FIG. 7A may be connected to or be a part of a network. For example, as shown in FIG. 7B, the network (720) may include multiple nodes (e.g., node X (722), node Y (724)). Each node may correspond to a computing system, such as the computing system shown in FIG. 7A, or a group of nodes combined may correspond to the computing system shown in FIG. 7A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (700) may be located at a remote location and connected to the other elements over a network.

The nodes (e.g., node X (722), node Y (724)) in the network (720) may be configured to provide services for a client device (726), including receiving requests and transmitting responses to the client device (726). For example, the nodes may be part of a cloud computing system. The client device (726) may be a computing system, such as the computing system shown in FIG. 7A. Further, the client device (726) may include and/or perform all or a portion of one or more embodiments.

The computing system of FIG. 7A may include functionality to present raw and/or processed data, such as results of comparisons and other processing. For example, presenting data may be accomplished through various presenting methods. Specifically, data may be presented by being displayed in a user interface, transmitted to a different computing system, and stored. The user interface may include a graphical user interface (GUI) that displays information on a display device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be a temporary, permanent, or semi-permanent communication channel between two entities.

The various descriptions of the figures may be combined and may include or be included within the features described in the other figures of the application. The various elements, systems, components, and steps shown in the figures may be omitted, repeated, combined, and/or altered as shown in the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, or is an “inclusive or” and, as such includes “and.” Further, items joined by an or may include any combination of the items with any number of each item unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method comprising:
obtaining a first real-world scenario of a plurality of agents moving according to a first plurality of trajectories;
simulating the first real-world scenario in a virtual world to generate a first plurality of simulated states, wherein simulating comprises:
processing, by an agent model, the first plurality of simulated states for the plurality of agents in the virtual world to obtain a second plurality of trajectories of the plurality of agents;
for each of at least a subset of the plurality of agents:
calculating a difference between a first corresponding trajectory of the agent and a second corresponding trajectory of the agent, wherein the first corresponding trajectory is in the first plurality of trajectories and the second corresponding trajectory is in the second plurality of trajectories, and
determining an imitation loss for the agent based on the difference;
evaluating the second plurality of trajectories according to a reward function to generate a reinforcement learning loss;
calculating a total loss as a combination of the imitation loss and the reinforcement learning loss; and
updating the agent model using the total loss.

2. The method of claim 1, wherein evaluating the second plurality of trajectories according to the reward function comprises:
for each of the at least a subset of agents:
individually calculating the reward function for the agent for a plurality of timesteps to generate a plurality of reward values for the agent, and
calculating an advantage function for the agent from the plurality of reward values to generate an advantage value for the agent,
calculating a policy loss for the at least the subset of agents using the advantage value for each agent of the at least the subset of agents,
calculating the reinforcement learning loss from the policy loss.

3. The method of claim 2, wherein calculating the policy loss comprises:
for each of the at least a subset of agents:
generating a ratio of a current probability to a historical probability,
wherein the current probability comprises a probability of the agent model performing an action of the second corresponding trajectory under a current agent model, and
wherein the historical probability comprises a probability of the agent model performing the action prior to a previous update of the agent model performing the action, and
multiplying the ratio by the advantage value to generate an intermediate value,
wherein the policy loss is calculated from the intermediate value for the at least the subset of agents using the advantage value for each agent of the at least the subset of agents.

4. The method of claim 3, wherein calculating the policy loss further comprises:
restricting the intermediate value prior to calculating the policy loss.

5. The method of claim 1, further comprising:
modifying a behavior characteristic of an agent of the plurality of agents to obtain a scripted agent with a modified behavior characteristic;
simulating a second scenario in the virtual world to generate a second plurality of simulated states, wherein the simulating comprises:
processing, by the agent model, the second plurality of simulated states for the plurality of agents, excluding the scripted agent, in the virtual world to obtain a third plurality of trajectories of the plurality of agents, and
simulating a scripted agent trajectory of the scripted agent according to the modified behavior characteristic;
evaluating the third plurality of trajectories and the scripted agent trajectory according to the reward function to generate a second reinforcement learning loss; and
updating the agent model according to the second reinforcement learning loss.

6. The method of claim 1, wherein the reward function is a sparse reward function.

7. The method of claim 1, wherein the reward function consists of at least one of an anticollision and a pathway deviation avoidance.

8. The method of claim 1, wherein updating the agent model comprises backpropagating the total loss through a graph neural network of the agent model.

9. The method of claim 1, further comprising:
simulating a second scenario to obtain a simulation result, wherein simulating the second scenario comprises iteratively:
generating a simulated environment state,
obtaining, from a virtual driver of an autonomous system, an actuation action that is based on the simulated environment state,
updating an autonomous system state based on the actuation action to obtain an updated autonomous system state,
modeling, by the agent model after the updating, a plurality of agent actions of the plurality of agents based on the updated autonomous system state, and
generating an updated simulated environment state; and
training the virtual driver according to the simulation result.

10. The method of claim 1, further comprising:
generating a plurality of map element nodes for a plurality of map elements defined in map data, the plurality of map element nodes connected by a first plurality of edges based on relative positions between the plurality of map elements;
generating a plurality of agent nodes for the plurality of agents, the plurality of agent nodes connected by a second plurality of edges identifying relative positions of the plurality of agents, the plurality of agent nodes comprising an agent encoding a plurality of relative historical positions of a corresponding agent with respect to a current position of the corresponding agent;
connecting, to generate a heterogeneous graph, the plurality of agent nodes to the plurality of map element nodes based on relative positions between the plurality of agents and the plurality of map elements; and
encoding, by an encoder model, an interaction encoding is performed by a graph neural network processing the heterogeneous graph.

11. A system comprising:
a computer processor; and
non-transitory computer readable medium for causing the computer processor to perform operations comprising:
obtaining a first real-world scenario of a plurality of agents moving according to a first plurality of trajectories,
simulating the first real-world scenario in a virtual world to generate a first plurality of simulated states, wherein simulating comprises:
processing, by an agent model, the first plurality of simulated states for the plurality of agents in the virtual world to obtain a second plurality of trajectories of the plurality of agents,
for each of at least a subset of the plurality of agents:
calculating a difference between a first corresponding trajectory of the agent and a second corresponding trajectory of the agent, wherein the first corresponding trajectory is in the first plurality of trajectories and the second corresponding trajectory is in the second plurality of trajectories, and
determining an imitation loss for the agent based on the difference,
evaluating the second plurality of trajectories according to a reward function to generate a reinforcement learning loss,
calculating a total loss as a combination of the imitation loss and the reinforcement learning loss, and
updating the agent model using the total loss.

12. The system of claim 11, wherein evaluating the second plurality of trajectories according to the reward function comprises:
for each of the at least a subset of agents:
individually calculating the reward function for the agent for a plurality of timesteps to generate a plurality of reward values for the agent, and
calculating an advantage function for the agent from the plurality of reward values to generate an advantage value for the agent,
calculating a policy loss for the at least the subset of agents using the advantage value for each agent of the at least the subset of agents,
calculating the reinforcement learning loss from the policy loss.

13. The system of claim 12, wherein calculating the policy loss comprises:
for each of the at least a subset of agents:
generating a ratio of a current probability to a historical probability,
wherein the current probability comprises a probability of the agent model performing an action of the second corresponding trajectory under a current agent model, and
wherein the historical probability comprises a probability of the agent model performing the action prior to a previous update of the agent model performing the action, and
multiplying the ratio by the advantage value to generate an intermediate value,
wherein the policy loss is calculated from the intermediate value for the at least the subset of agents using the advantage value for each agent of the at least the subset of agents.

14. The system of claim 13, wherein calculating the policy loss further comprises:
restricting the intermediate value prior to calculating the policy loss.

15. The system of claim 11, wherein the operations further comprise:
modifying a behavior characteristic of an agent of the plurality of agents to obtain a scripted agent with a modified behavior characteristic,
simulating a second scenario in the virtual world to generate a second plurality of simulated states, wherein the simulating comprises:
processing, by the agent model, the second plurality of simulated states for the plurality of agents, excluding the scripted agent, in the virtual world to obtain a third plurality of trajectories of the plurality of agents, and
simulating a scripted agent trajectory of the scripted agent according to the modified behavior characteristic,
evaluating the third plurality of trajectories and the scripted agent trajectory according to the reward function to generate a second reinforcement learning loss, and
updating the agent model according to the second reinforcement learning loss.

16. The system of claim 11, wherein the reward function is a sparse reward function.

17. The system of claim 11, wherein the reward function consists of at least one of an anticollision and a pathway deviation avoidance.

18. A non-transitory computer readable medium comprising computer readable program code for causing a computer system to perform operations comprising:
obtaining a first real-world scenario of a plurality of agents moving according to a first plurality of trajectories;
simulating the first real-world scenario in a virtual world to generate a first plurality of simulated states, wherein simulating comprises:
processing, by an agent model, the first plurality of simulated states for the plurality of agents in the virtual world to obtain a second plurality of trajectories of the plurality of agents;
for each of at least a subset of the plurality of agents:
calculating a difference between a first corresponding trajectory of the agent and a second corresponding trajectory of the agent, wherein the first corresponding trajectory is in the first plurality of trajectories and the second corresponding trajectory is in the second plurality of trajectories, and
determining an imitation loss for the agent based on the difference;
evaluating the second plurality of trajectories according to a reward function to generate a reinforcement learning loss;
calculating a total loss as a combination of the imitation loss and the reinforcement learning loss; and
updating the agent model using the total loss.

19. The non-transitory computer readable medium of claim 18, wherein evaluating the second plurality of trajectories according to the reward function comprises:
for each of the at least a subset of agents:
individually calculating the reward function for the agent for a plurality of timesteps to generate a plurality of reward values for the agent, and
calculating an advantage function for the agent from the plurality of reward values to generate an advantage value for the agent,
calculating a policy loss for the at least the subset of agents using the advantage value for each agent of the at least the subset of agents,
calculating the reinforcement learning loss from the policy loss.

20. The non-transitory computer readable medium of claim 19, wherein calculating the policy loss comprises:
for each of the at least a subset of agents:
generating a ratio of a current probability to a historical probability,
wherein the current probability comprises a probability of the agent model performing an action of the second corresponding trajectory under a current agent model, and
wherein the historical probability comprises a probability of the agent model performing the action prior to a previous update of the agent model performing the action, and
multiplying the ratio by the advantage value to generate an intermediate value,
wherein the policy loss is calculated from the intermediate value for the at least the subset of agents using the advantage value for each agent of the at least the subset of agents.
